(19) United States
(12) Patent Application Publication
(10) Pub. No.: US 2006/0090319 A1
(43) Pub. Date: May 4, 2006

(54) Defect locating system for moving web

(76) Inventor: Major K. Howe, Abbeville, SC (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/978,341

(22) Filed: Nov. 1, 2004

(51) Int. Cl. B23P 6/00; G01M 19/00

(52) U.S. Cl. 29/407.05; 29/17.2; 29/402.11; 29/402.06; 29/407.04; 29/709

(57) ABSTRACT

Included in this disclosure are methods for locating defects on a web material. The methods include searching a web for defects and creating a roll defect map. Searching for web defects may take the form of any of a plurality of procedures including using a vision defect sensor and/or a gauging defect sensor. Also included in the methods are marking the web at intervals along the length of the web, wherein the web markings are readable by a sensor. The methods also include forming the web into a spiral wound roll and communicating the roll defect map to a defect locator. The methods also synchronize the web markings with the roll defect map; and automatically locates at least one defect on the web.

### TECHNICAL FIELD

This disclosure relates to detecting defects in paper or other web stock of long lengths and removing the defects.

### BACKGROUND

During the manufacture of long webs of material, such as paper, plastics (film and sheet), coated sheets or saturations of all kinds, rubber, non-woven and woven textiles, there is a likelihood that defects will appear in the web, causing certain portions of the web to be considered defective and unfit for the intended use. Usually the web material is manufactured continuously in very long lengths at high speeds and accumulated in very large spiral wound rolls. When a defect in the web is identified, it is difficult to determine where the defect is located in the finished roll. It is important to know where the defects occur along the long lengths of the web so that the manufacturer can later locate and treat the defects on the web.

Generally, the manufacturer of webs use gauges and other types of sensors to measure the basis weight, moisture content, and/or thickness of the web. The sensors can be fixed in a position immediately adjacent the web so as to continuously perform their measuring functions and in some cases, the sensors can be moved back and forth across the oncoming web, creating a zigzag measurement path as the web moves by the sensor.

Another type of process control device for determining the quality of a moving web is called a vision defect sensor. In this case, a combination of lighting and cameras provides one hundred percent visual inspection of the web during its production. This system uses various software techniques to find, label, and count all types of visible product defects along the length of the moving web.

Generally, the gauging and vision defect sensors described above provide a product called a roll defect map. The system records the blemishes, flaws, and other defects and a computer system prepares a graph or “map” that illustrates the web and the defects in the web. This may be done on a small scale basis with the web illustrated on the map in small dimensions, such as inches or millimeters across the width of the web and by feet or meters along the length of the web. The maps are used by the converter to locate and remove the defects from the web when the original web is to be split into smaller rolls or otherwise converted for final use.

When the large original or “master” roll has been accumulated from the web making machine, it must be doffed when it reaches a predetermined size and a new roll started. The doffed roll then will be trimmed so as to make the roll more aesthetic, or easier to handle, and several layers of the web might be removed from the roll by production workers. In many cases, when a portion of the length of the web material is removed from the roll, the map or graph made of the web material becomes useless since there is some difficulty in determining exactly how many feet of the roll were removed during the trimming process, and the roll maps for each of the process control devices usually are discarded. Even if not discarded, the roll maps become incapable of providing the converter of the roll from its original condition accurate information to find the individual defects in the web.

### SUMMARY

The defect locating system as disclosed herein is designed to assist the converter to find the correct length of the master roll and thus restore the usefulness of the roll defect map.

The defect locating system includes an encoding marking device that is positioned along the path of movement of the web and will mark the web at selected intervals along the web. These indicator marks may include length data and possibly other information such as the identification of the roll, the material of the web, the customer I.D., the purchase order number, etc. usually are applied when the web is first being produced, but the same encoding process can be used at other times, usually when the web is moved along its length. The marks can be permanently or temporarily applied to the web, including when the web is wound into a spiral roll at the end of the web making process. These marks may be printed, scorched or burned, tagged with labels, color coded, sprayed, or may take any appropriate form to keep track of the chronological footage of the length of the web as it is being made and to provide other information, if desired, for later use.

If the master roll of web material is being split during production to provide two or more narrower rolls, it might be necessary to mark the web in more than one location in the cross machine direction. With this approach, each smaller web will bear the encoding length marks at predetermined intervals along its length for later detection and use.

In addition to the encoding marking device on the production line, there is also a decoding device on or close to the unwind stand. When the master or portion of a master roll is to be unwound, a mark decoding device, which may include camera or other sensor is positioned along the anticipated path of the web material, in alignment with the anticipated markings previously applied to the web material. The mark decoding device picks up an encoded mark that is found on the roll as the roll unwinds. The found mark may have a unique identification number that provides the mark decoding device with information to determine what portion of the web is moving adjacent the detector. The mark decoding device then establishes the remaining length of the entire roll and re-registers the web with the roll defect maps of the process control devices. The amount of scrapped material that was removed from the roll also can be determined from this first encoded mark, by subtracting the first indicated length from the original total footage produced.

Since roll defect maps are traditional software products of the process control devices, they can be communicated by Ethernet, local area network (LAN), or other comparable means to the decoding device to electronically manage the roll defect map with the actual footage of the roll as measured by the defect locating system and automatically adjust the unwind stand to find any particular defect that was detected and recorded by the computer.

### BRIEF DESCRIPTION OF THE DRAWINGS

FIG. 1 is a schematic illustration of a system for detecting defects as a web material moves from a web making machine toward a roll stand.

FIG. 2 is a partial view of the web of FIG. 1 as it moves from the web making machine to the roll stand, illustrating how a gauging defect sensor may move back and forth across the oncoming web.

FIG. 3 is a partial view of the web from FIG. 1, illustrating how a vision defect sensor may scan the web material 10.

FIG. 4 is a schematic illustration of a roll defect map created from the defect detecting system of FIG. 1.

FIG. 5 is a partial view of the web material from FIGS. 2 and 3, further illustrating a plurality of encoding marking devices.

FIG. 6 is a partial view of the web material from FIG. 5 illustrating the benefits of multiple encoding marking devices when a web is divided into smaller rolls for subsequent use.

FIG. 7 is a perspective view of the spiral wound roll from FIG. 1 illustrating various ways for dividing the roll for subsequent use.

FIG. 8 is a schematic illustration of the spiral wound roll from FIG. 7 on an unroll stand.

FIG. 9 is a flowchart diagram illustrating a process undergone for detecting and treating defects on a web.

### DETAILED DESCRIPTION

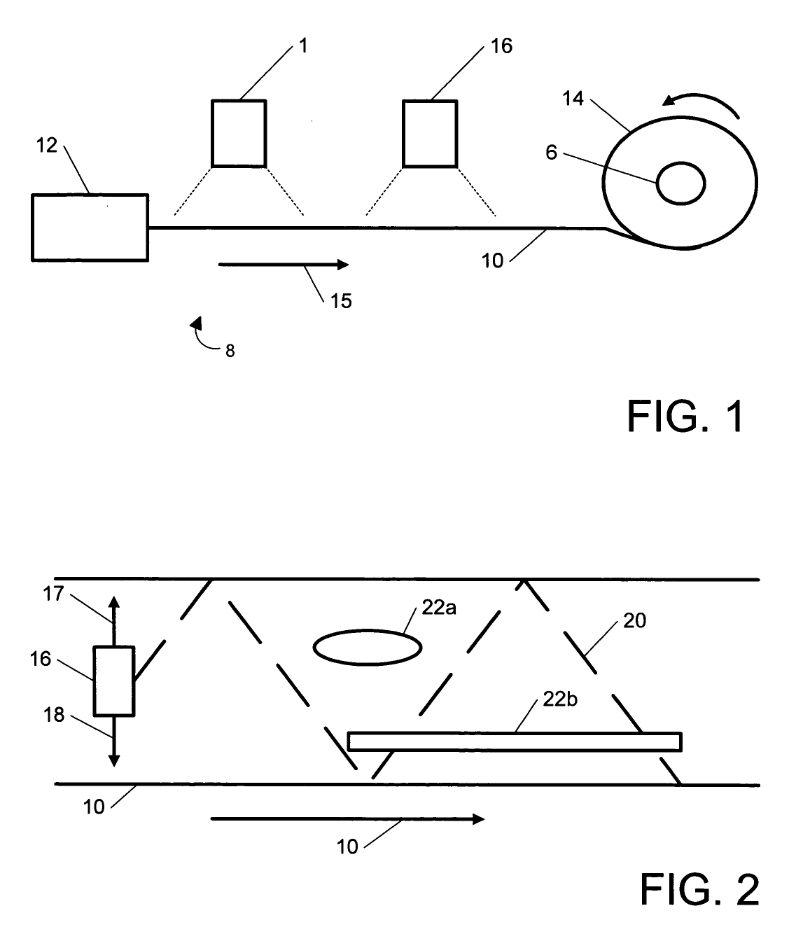

FIG. 1 is a schematic illustration of a system 8 for detecting web defects as a web material 10 moves from a web making machine 12 toward a roll 14 of a roll stand 6. In this nonlimiting example, the web material 10 advances to the right in the direction of arrow 15. As the roll 14 on the roll stand 6 is rotated counter-clockwise, the web material is accumulated onto the roll stand 6 to form the spiral wound roll 14. Also shown in FIG. 1 are a vision defect sensor 1 and a gauging defect sensor 16. The vision defect sensor 1 may include any of a plurality of sensors. However in this nonlimiting example, the vision defect sensor 1 comprises a plurality of cameras with at least one light source. The vision defect sensor 1 is configured to scan the entire width of the web material 10 while remaining stationary.

The gauging defect system of this nonlimiting example, however comprises a defect detection sensor that traverses back in forth across the width of the web material 10. Along with the motion of the web material 10 in the direction of arrow 15, the motion of the gauging defect sensor 16 creates a zigzag pattern along the web material 10.

As is evident to one of ordinary skill in the art, the web making machine 12 may take the form of a paper mill, a plastic manufacturer, or other system capable of producing a product in web form. Similarly, other representations in this and other examples of this disclosure are simply nonlimiting examples, and are not intended to constrain the present disclosure to those limitations.

FIG. 2 is a partial view of the web material 10 from FIG. 1 as it moves from the web making machine 12 to the roll stand 6, illustrating how a gauging defect sensor 16 may traverse the width of the oncoming web material 10. The web material 10 is depicted from an overhead view with the gauging defect sensor 16 moving back and forth in the direction of arrows 17 and 18. As the web material 10 is advanced in the direction of arrow 15, the oscillating motion of the gauging defect sensor 16 translates into a zigzag configuration 20 on the web material 10. This motion allows for the sensing of a streak defect 22b. The streak defect 22b may include any defect that may cross the sight line of the gauging defect sensor 16. However, other defects such as a spot defect 22a may be missed by this method. The spot defect 22a may comprise any defect undetectable by the gauging defect sensor 16. Such a defect may be undetectable for any of a plurality of reasons including size or type of defect. Similarly, the gauging defect sensor 16 may not detect a desired defect when certain types of products are being produced that are small in nature. Examples of such products include credit cards, napkins, business cards, and the like. As such, other types of defect sensors may be also implemented to detect the desired web defects.

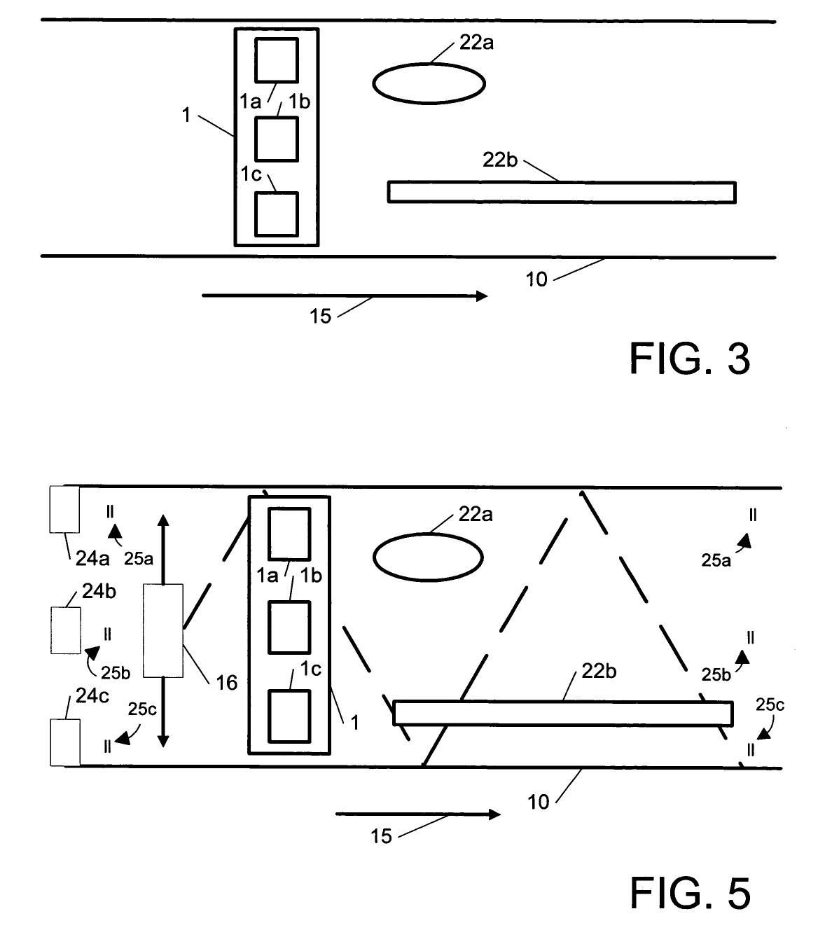

FIG. 3 is a partial view of the web material 10 from FIG. 1, illustrating how a vision defect sensor 1 may scan the web material 10. As shown in FIG. 3, the web material 10 is advanced in the direction of arrow 15, thereby allowing both defects 22a and 22b to pass under the vision sensor 1. The vision sensor 1 in this nonlimiting example, includes cameras 1a, 1b, and 1c. The vision sensor 1 not only has the ability to view the entire width of web material 10 while staying stationary; it also has the ability to determine the formation of the web material 10. Formation refers to the uniformity of color and texture of a particular material. As a nonlimiting example, the paper in a brown paper bag will generally appear more blotchy and feel less uniform than linen resumé paper. The linen resumé paper would have a higher formation. In production, the paper bag formation may not be very important, as the aesthetic appeal is of little concern in a paper bag. On the other hand, formation of the web material 10 may play a large part in the quality control of the resumé paper, as its uniformity is a top priority.

As such, the vision sensor 1 has the ability to detect defects on the web material 10 such as the spot defect 22a that the gauging defect sensor 16 may be unable to detect.

Similarly, as vision sensor 1 scans the entire width of the web material 10, it also has the ability to detect smaller defects that are missed by the zigzag motion of the gauging defect sensor 16.

Although two different types of defect sensors are discussed herein, the present disclosure is not limited to merely these representations. Other defect sensors may be used in addition to or in substitution with the above discussed defect sensors.

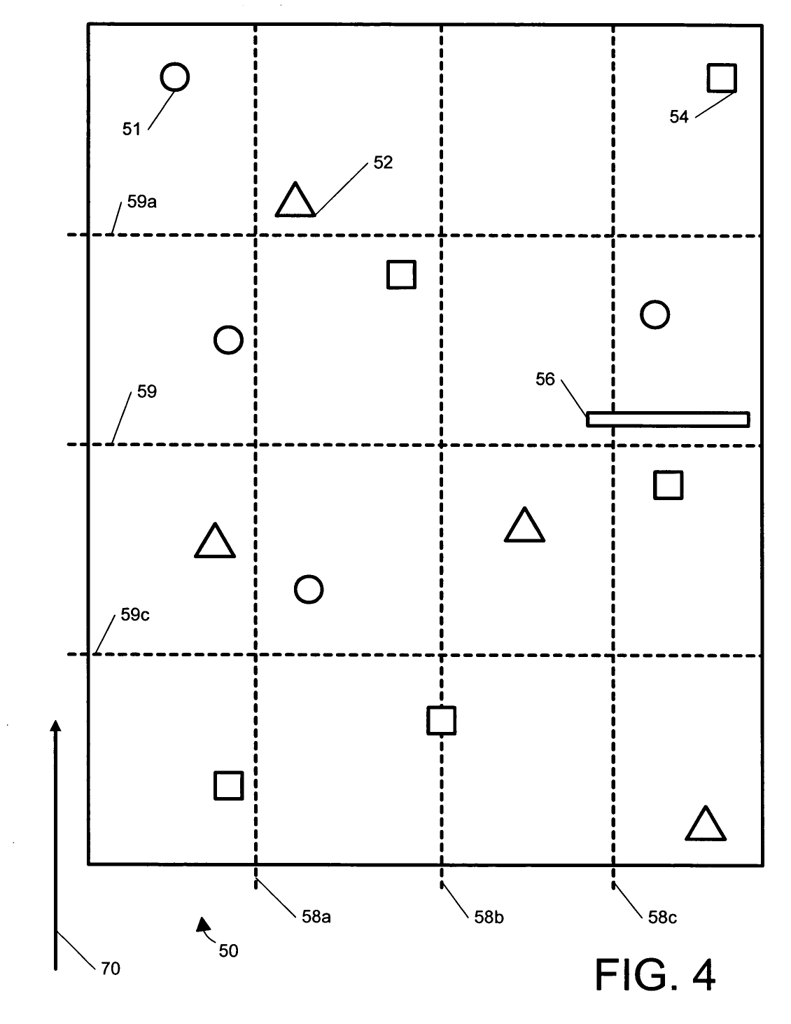

FIG. 4 is a schematic illustration of a roll defect map 50 created from the defect detecting system 8 of FIG. 1. Roll defect map 50 is used for charting defects on the web material 10. Roll defect map 50 generally takes the form of computer data that indicates where defects are located. The data may be presented on a computer monitor or other display for a system operator to view and may advance in the direction of arrow 70. The visual display of roll defect map 50 may take the same dimensions as web of material 10, but more than likely, the roll defect map 50 will be scaled to a size more manageable for a system operator to view (or others who may view this data). The system operator or a system computer may determine which defects are selected for treatment. Depending on the type of web material 10, and its eventual use, certain defects may be allowable, while others may be treated.

The roll defect map 50 may include a plurality of defects, each denoted with a different shape. Defect 51 is represented with a circle, while defect 52 is represented with a triangle. Defect 54 is represented with a square and defect 56 is illustrated with a rectangle. Roll defect map 50 is divided into a grid with longitudinal divisions indicated as dashed lines 58a, 58band 58c. Roll defect map 50 is laterally divided as shown with horizontal dashed lines 59a, 59b and 59c. These divisions help the defect locating system locate the defects with more precision.

As is evident to one of ordinary skill in the art, these shapes illustrate certain types of defects that may be located on the web material 10. Any of a plurality of types of defects may be represented on roll defect map 50. The representations of different defects may vary from system to system, and a given system may be configured to only display defects that are in need for treatment. As is also evident to one of ordinary skill in the art, the shape depictions of defects represented in FIG. 4 are merely nonlimiting examples. Any of a plurality of symbols can be used including, but not limited to shapes, numbers, letters, pictures, colors, bar codes, or any combination thereof.

FIG. 5 is a partial view of the web material 10 from FIGS. 2 and 3, further illustrating a plurality of encoding marking devices. As shown in FIG. 5, the gauging defect sensor 16 traverses the width of the web material 10 as shown above. Further, vision defect sensor 1, which includes vision cameras 1a, 1b, and 1c also scan the web material 10 for defects. As stated above, any number of defect sensing apparatus can be implemented.

Additionally included in this illustration are means for inserting at least one indicator mark on the web material 10, illustrated as encoding marking devices 24a, 24b, and 24c. Indicator marks are denoted in FIG. 5 as 25a, 25b, and 25c. Indicator marks are marks that may communicate any of a plurality of information to the defect locating system. As a nonlimiting example, the encoding marking devices 25a, 25b, and 25c may indicate the distance from the beginning of the web material 10 to the present location. Further, the indicator marks 25a, 25b, and 25c may indicate customer number, material type, product, type, and/or any other pertinent information.

To fully communicate the appropriate data, the encoding marking devices 24a, 24b, and 24c may be configured to mark the web material 10 at given intervals along its length. The intervals may be linear, nonlinear, or even random. As a nonlimiting example, a linear interval may include marking the web material 10 at every three feet. A nonlimiting example of a nonlinear interval might be marking the web material (10) 100 feet after the roll begins, then 50 feet later, then 25 feet later, etc. Such a nonlinear configuration may be beneficial when the web is unlikely to be cut until later in the rolling process.

In addition, the indicator marks 25a, 25b, and 25c may take any conceivable form, and are not limited to the double tick marks shown in FIG. 5. As a nonlimiting example, the indicator marks 25a, 25b, and 25c may take the form of binary code, one or two dimensional bar code, colors, shapes, or any other means to communicate data. Further, indicator marks 25a, 25b, and 25c may be burned, scorched, etched, glued, written in visible or invisible ink, or any other detectable means for adhering indicator marks 25a, 25b, and 25c to the web material 10.

It should also be noted that the plurality of encoding marking devices 24a, 24b, and 24c may also be configured to communicate directly with gauge defect sensor 16, vision defect sensor 1, or any other type of defect sensing device. In such a configuration, encoding marking devices 24a, 24b, and 24c may insert data onto the web material 10 concerning the type of defect, its exact location, the proscribed treatment method, etc. As stated above, this data may take any of a plurality of forms including, but not limited to colors, numbers, symbols, binary code, or bar code. Further, the data may be burned, scorched, etched, glued, written in visible or invisible ink, or any other detectable means for adhering the data to the web material 10.

Finally, it should also be noted that while FIG. 5 indicates the indicator marks 25a, 25b, and 25c as three in number, the present disclosure also contemplates any number of encoding marking devices for applying indicator marks for communicating the desired information to the desired recipient. When the web material 10 is to be divided longitudinally to form two or more rolls, it is usually desirable to apply indicator marks on the original web at positions where the edges of the cuts are to be made in the original web for detection of web position, length, etc. for each cut roll of the web material 10.

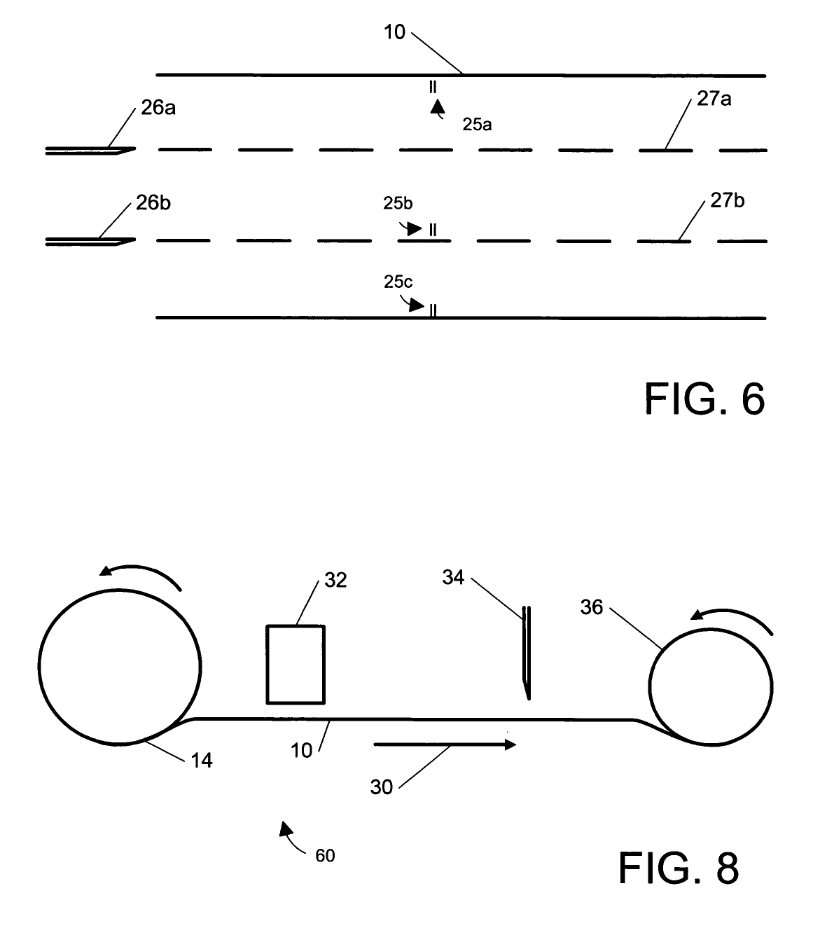

FIG. 6 is a partial view of the web material 10 from FIG. 5, illustrating the benefits of multiple length makers when a web is divided into smaller rolls for subsequent use. The web material 10 is cut into three sections as shown by dashed lines 27a and 27b. The division may be performed by cutters 26a and 26b. The encoding marking devices 24a, 24b and 24c of FIG. 5 may be positioned such that when the web material 10 is cut in this manner, each section will still retain its respective indicator mark. As is evident to one of ordinary skill in the art, any number of divisions may be made to the web material 10, and the indicator marks 25a, 25b, and 25c may correlate with the number of divisions, but are not constrained to such a configuration.

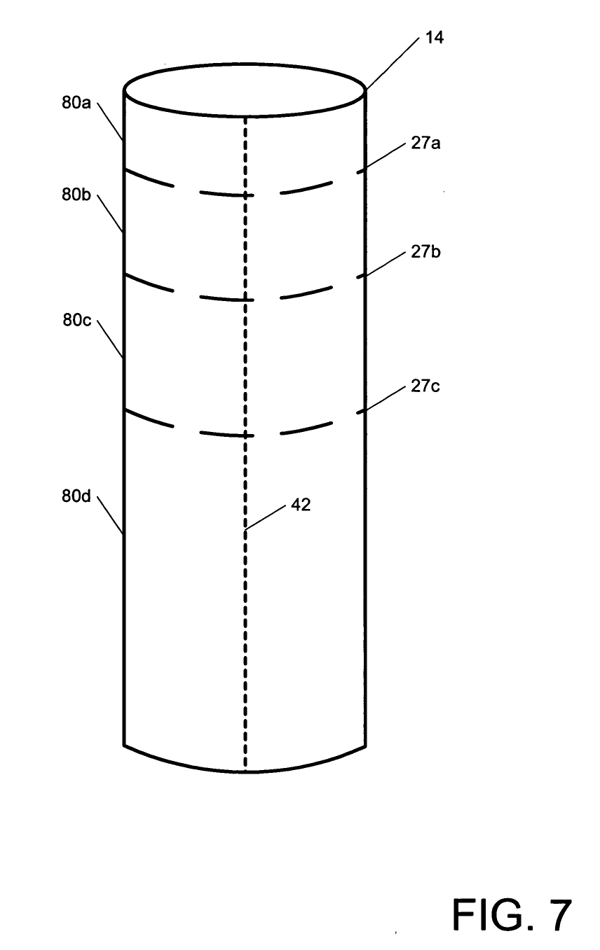

FIG. 7 is a perspective view of the spiral wound roll 14 from FIG. 1, illustrating various ways for dividing the roll for subsequent use. As shown in FIG. 7, round spiral roll 14 may be divided along dashed lines 27a, 27b and 27c to create a plurality of smaller special purpose rolls 80a, 80b, 80c, and 80d. These divisions may serve to create equal-sized special purpose rolls 80a, 80b, 80c, and 80d, but more than likely these divisions will create rolls of different sizes.

Further, as described above, the wound spiral wound roll 14 may also be cut lengthwise along dashed line 42 by means for trimming to trim the scrap material from the roll. When the spiral wound roll 14 is cut in this manner, oftentimes it is difficult to determine the amount of material removed from spiral wound roll 14. Encoding marking devices 24a, 24b, and 24c (FIG. 5), along with mark decoding device 32 (FIG. 8) help to re-synchronize web material 10 with roll defect map 50 (FIG. 4).

FIG. 8 is a schematic illustration of the spiral wound roll 14 from FIG. 7 on an unroll stand 60. As shown in FIG. 8, the spiral wound roll 14 is unrolled and the web material 10 is advanced in the direction of arrow 30. Mark decoding device 32 receives roll defect map 50 of FIG. 4 and also contains a sensor, which reads and decodes the indicator marks 25a, 25b and/or 25c of FIG. 5. The roll defect map 50 is advanced along its length in timed relationship with the advancement of the web material 10 to synchronize roll defect map 50 with the indicator marks. Synchronization gives the mark decoding device 32 the ability to determine the length of the web material 10, as well as exactly where each defect is located. Further, a plurality of other information may also be ascertained such as the number of special purpose rolls 80a, 80b, 80c, or 80d that may be produced from the web material 10.

As the web material 10 is advanced in the direction of arrow 30, final roll 36 accumulates the web material 10. This process continues until the mark decoding device 32 locates a defect to be treated. At this time, the unwind stand 60 stops advancement of the web material 10, so an operator or system can treat the defect. Also at this time, advancement of roll defect map 50 stops. As is evident to one of ordinary skill in the art, treating the defect may include using cutting apparatus 34 to cut out the defect from web material 10 or to remove an entire area of the web material 10. The roll defect map 50 also resumes its advancement in timed relationship with the web material 10. Treating the defect may also include using a method that allows the web material 10 to remain intact. Once the defect is treated, the unwind stand 60 may resume advancing the web material 10 until the next defect is located. This process may continue until the last defect is treated.

It should also be noted that in an alternate configuration indicator marks 25a, 25b, and 25c may contain any or all the data necessary to perform the actions stated above. In such a configuration, roll defect map may or may not be needed to treat defects located on the web material 10. As a nonlimiting example, gauging defect sensor 16 and vision defect sensor 1 may be configured to communicate directly with encoding marking devices 24a, 24b, and 24c. In such a scenario, the encoding marking devices 24a, 24b, and 24c can insert all the necessary data concerning the web and defects locate therein onto web material 10, via indicator marks 25a, 25b, and 25c. In such a configuration, the mark decoding device 32 could be configured to decode indicator marks 25a, 25b, and 25c, and perform the desired actions as indicated. Desired actions may include making various calculations concerning the web material 10, locating various defects on the web material 10, determining which defects are to be treated, and treating the appropriate defects. Such a configuration may be implemented when transmission of the roll defect map 50 from one location to another is impracticable, inefficient, or otherwise undesired.

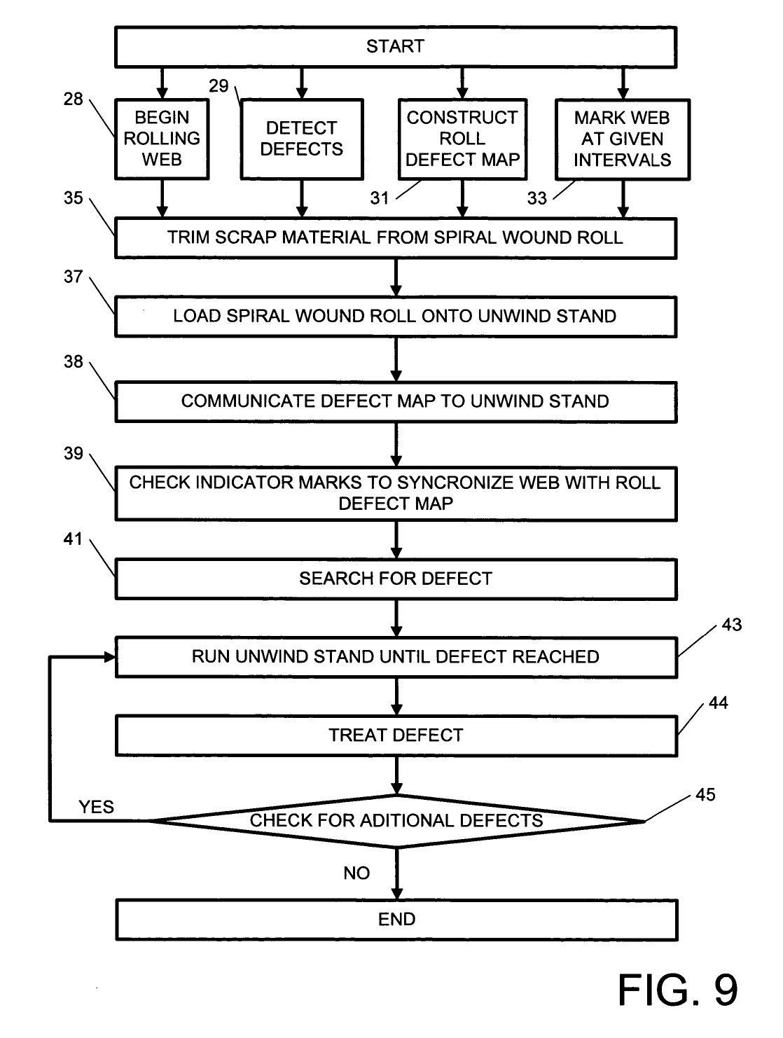

FIG. 9 is a flowchart diagram illustrating a process 30 undergone for detecting and treating defects on the web material 10. As shown in FIG. 9, the process 30 begins by rolling the web material 10 onto roll stand 6, as shown in block 28. Also, the process 30 detects defects as shown in block 29, and constructs the roll defect map 50, as shown in block 31. The process 30 also marks the web material 10 with indicator marks 25a, 25b, and/or 25c at given intervals, as depicted in block 33. Block 35 illustrates that the process 30 trims the scrap material from the spiral wound roll 14. This may be accomplished by human personnel such as a floor worker, or by a machine configured to trim the spiral roll at the appropriate time.

Block 37 illustrates that the spiral wound roll is loaded onto the unwind stand. As is evident to one of ordinary skill in the art, unwind stand may be part of the same apparatus, and thus this step may be excluded. Block 39 illustrates that the web markings are checked to synchronize the defect roll map 50 with the web material 10. Block 41 depicts that the process 30 searches the web for the defects in roll defect map 50. As stated above, searching for defects includes comparing the defect roll map 50 with the web material 10 and indicator marks 25a, 25b, and 25c. When this comparison is made, the process 30 may simply find the desired defect on the roll defect map 50, and advance the web material 10 to that position.

Block 43 illustrates that the unwind stand 60 is run until a defect is found. As is evident to one of ordinary skill in the art, because the process 30 has identified where the next desired defect is located, unwind stand 60 may advance web material 10 at a very high speed until that position is reached. This increases production of the final product by eliminating the need for visual inspection at this point in the process. When the unwind stand reaches a defect, process 30 stops unwind stand and indicates that the defect is to be treated as shown in block 44. The process 30 checks for additional defects on roll defect map 50, as shown in module 45. If additional defects are found on the roll defect map 50, the process 30 returns to block 43 and resumes unwinding until another defect is reached. If no additional defects remain, the process ends.

Although the preferred embodiments of the invention have been described in detail herein and, it would be obvious to those of ordinary skill in the art that variations and modifications of the disclosed embodiments can be made without departing from the sphere and the scope of the invention as set forth in the following claims.

At least the following is claimed:

1. A method of detecting and removing blemishes from a web of material, comprising:
advancing a web along a first processing path,
as the web advances along the first processing path, marking the web with length marks that indicate lengths along the web,
as the web advances along the first processing path detecting blemishes in the web,
in response to the detection of each blemish in the web, recording the length mark adjacent each blemish along the length of the web, and
accumulating the web in a spiral wound roll,
un-reeling the roll and advancing the web from the roll along a second processing path,
as the roll advances along the second processing path, detecting the length marks on the web, and
in response to the detection of a length mark on the web at the location of a blemish, treating the blemish.

2. The method of claim 1, wherein
the step of treating the blemish comprises removing the area of the web that contains the blemish.

3. The method of claim 1, wherein
the step of advancing a web along a first path comprises advancing a web selected from a group consisting essentially of:
paper, plastic, coated sheet material, saturated sheet material, rubber, textile, and non-woven, and woven materials.

4. The method of claim 1, wherein
the step of accumulating the web in a spiral wound roll comprises accumulating the web in a master roll,
and further including the step of separating the master roll into at least two spiral wound rolls,
wherein the step of marking the web with length marks comprises marking the web at a position spaced across the width of the web that corresponds to the position where the master roll is to be separated into at least two spiral rolls.

5. A web having a width and an undetermined length, computer readable length marks applied to the web at intervals along the length of the web,
blemishes at random intervals along the length of the web, and
the web formed into a spiral wound roll.

6. The web of claim 5, wherein
wherein the web includes more than one set of computer readable length marks applied to the web.

7. The web of claim 5 and further including
a program of finding the blemishes in response to a length mark moving from the spiral wound roll past a computer reader.

8. The web of claim 5, wherein
said web is selected from the group consisting of: rubber, non-woven and woven textiles, paper, plastic sheets, plastic films, coated sheets, and saturated sheets.

9. The web of claim 5, wherein
the computer readable length marks include web identification information.

10. A method for locating defects on an elongated web, comprising:
advancing the web along its length;
as the web is advanced, searching the web for defects;
marking the web at intervals along the length of the web with at least one indicator mark, wherein the at least one indicator mark is readable by a sensor and comprises at least one piece of encoded data;
forming the web into a spiral wound roll;
decoding data from the at least one indicator mark;
automatically locating at least one defect on the web based on the data decoded from the at least one indicator mark.

11. The method of claim 10, further comprising treating the at least one defect.

12. The method of claim 10, wherein the web is selected from a group consisting essentially of paper, plastic, coated sheet material, saturated sheet material, rubber, textile, and non-woven and woven materials.

13. The method of clam 10, further comprising:
dividing the spiral wound roll into a plurality of special purpose rolls;
wherein marking the web with at least one indicator mark comprises marking the web at a position spaced across the width of the web that corresponds to the position where spiral wound roll is separated into a plurality of special purpose rolls.

14. the method of claim 10, wherein searching the web for defects comprises using at least one of: a vision defect sensor and a gauging defect sensor.

15. The method of claim 10, further comprising calculating at least one property of the spiral wound roll.

16. The method of claim 10, further comprising trimming scrap from the spiral wound roll.

17. The method of claim 10, further comprising creating a roll defect map that corresponds to the web and defects on the web.

18. The method of claim 17, further comprising synchronizing movement of the web with the roll defect map.

19. A system for locating defects on a web, comprising:
a web having an undetermined length;
at least one defect on the web;
logic configured to detect defects on the web;
means for inserting at least one indicator mark on the web, the at least one indicator mark being readable by a sensor and comprises at least one piece of encoded data;
logic configured to decode data from the at least one indicator mark; and
logic configured to locate a defect on the web using the data decoded from the at least one indicator mark.

20. The system of claim 19, further comprising a network configured to communicate the roll defect map from a first position to a second position.

21. The system of claim 19, wherein the web is selected from the group consisting essentially of paper, plastic, coated sheet material, saturated sheet material, rubber, textile, and non-woven and woven materials.

22. The system of claim 19, further comprising means for trimming scrap from the spiral wound roll.

23. The system of claim 19, wherein the roll defect map is created from data generated from any of: a vision defect sensor and a gauging defect sensor.

24. The system of claim 19, further comprising logic configured to calculate at least one property of the spiral wound roll.

25. The system of claim 19, further comprising logic configured to create a roll defect map.

26. The system of claim 25, further comprising logic configured to synchronize the roll defect map with the web.
